(19) United States
(12) Patent Application Publication
(10) Pub. No.: US 2008/0103813 A1
(43) Pub. Date: May 1, 2008

(54) System and method for portable safeguard context in a patient's room

(76) Inventors: Kavita Agrawal, Austin, TX (US); William K. Bodin, Austin, TX (US); Gregory W. Rybczynski, Pfugerville, TX (US)

Correspondence Address: IBM CORPORATION (RHF), C/O ROBERT H. FRANTZ, P. O. BOX 23324, OKLAHOMA CITY, OK, 73123, US

(21) Appl. No.: 11/548,849

(22) Filed: Oct. 12, 2006

(51) Int. Cl. G06Q 10/00

(52) U.S. Cl. 705/2

(57) ABSTRACT

According to a patient role and permissions indicators, an origin safeguard context including a patient origin location identifier, an associated origin space safeguard profile, and at least one associated previously-established set of control parameters, limit settings, and controllable device configurations are reconciled with a patient destination location identifier and an associated destination space safeguard profile to produce a destination safeguard context including a destination location set of control parameters, limit settings, and controllable device configurations. One or more destination facility configurations are controlled according to the destination safeguard context to provide automated portable safeguard contexts of in-room equipment such as patient monitors, gas valves, door locks, light switches, electricity sources, power furniture adjusters, and bedside instruments.

### BACKGROUND OF THE INVENTION

1. Field of the Invention

This invention pertains to technologies employed to provide safety features in areas where hazards may be posed to patients in a hospital room, outpatient center, recovery room, or other medical treatment facility.

2. Background of the Invention

Hospitals are typically thought to be a safe place for patients. However, many pieces of equipment and facilities in hospital rooms, as well as other areas in hospitals, present dangers to patients. These threats can include but are not limited to scalding hot water temperatures, explosive gases, high voltage sources, equipment which can cause injury or death if improperly controlled, and motorized furniture which can cause injury to limbs at pinch points.

For example, an outpatient surgery is performed on a patient in a hospital operating room (“OR”). After the surgery, the patient is moved to a recovery room for monitoring, where his wife and children are allow to visit and stay with the patient as he wakes up from the anesthesia. In the recovery room, there is the patient's bed that can adjust for height and elevation, and a heart monitor and related vital signs machines are running to ensure no complication results from the surgery. These monitors allow nurses to manage various recovery room patients remotely from a centralized location.

During a patient's recovery or treatment, however, the patient may not be completely lucid or cognizant. The patient's reduction mental capabilities, physical coordination, or both, can be due to medication side effects, therapy results, the illness from which the patient suffers, or a combination of these factors. Because there are few, if any, security features on these monitoring devices and other in-room dangers, the patient can accidentally touch a button, trip over the machine wires and knock something over, or simply step on the bed height adjustment peddle and cause problems in the recovery room. For example, certain patient conditions may lead to the patient being the source of the accident, such as dementia, Alzheimer's syndrome, or even being in a reduced mental or physical capacity due to drug effects (e.g. anesthesia, pain killers, etc.), appliances (e.g. casts, braces, etc.), or therapies. Patients in conditions such as these can also change equipment settings, trip over tubes and cables, or open explosive gas jets.

These conditions pose a danger to the visitors and especially to the patient, as well as to other patients and staff in the hospital. Attentive nursing and hospital staff may reduce these dangers to a degree through careful adjustment of certain equipment controls, restraining the patient during times in which the patient would be likely to cause a problem, etc. However, this is not a reliable system to address these dangers, and these measures can be uncomfortable to the patient.

Additionally, when a patient is transferred from one room to another, such as from surgical recovery to longer term infirmary care, or from one specialty wing of a hospital to another specialty wing, the level of vigilance and care against these types of problems may not be continuous. As movement of patients within a hospital, clinic, or surgical facility is common, these potential problems and risks are only exasperated.

### BRIEF DESCRIPTION OF THE DRAWINGS

The following detailed description when taken in conjunction with the figures presented herein provide a complete disclosure of the invention.

FIG. 1 depicts a logical process according to the present invention for transferring control settings, limits, and configurations from a first patient room or environment to a second patient room or environment.

FIGS. 2a and 2b show a generalized computing platform architecture, and a generalized organization of software and firmware of such a computing platform architecture.

FIG. 3a sets forth a logical process to deploy software to a client in which the deployed software embodies the methods and processes of the present invention.

FIG. 3b sets for a logical process to integrate software to other software programs in which the integrated software embodies the methods and processes of the present invention.

FIG. 3c sets for a logical process to execute software on behalf of a client in an on-demand computing system, in which the executed software embodies the methods and processes of the present invention.

FIG. 3d sets for a logical process to deploy software to a client via a virtual private network, in which the deployed software embodies the methods and processes of the present invention.

FIGS. 4a, 4b and 4c, illustrate computer readable media of various removable and fixed types, signal transceivers, and parallel-to-serial-to-parallel signal circuits.

FIG. 5a shows an example floor plan of a hypothetical hospital.

FIG. 5b shows an example floor plan of a hypothetical hospital for reference to example embodiments and example modes of use of the invention.

FIGS. 6a, 6b, and 6c depict arrangements of systems and network(s) according to the invention.

FIG. 7a illustrates a hypothetical surgical recovery room floor plan enhanced to be controlled in a manner according to the invention.

FIG. 7b illustrates a hypothetical hospital room floor plan enhanced to be controlled in a manner according to the invention.

FIG. 7c depicts the transfer of control setting, limits, and configurations from a first patient room or environment to a second patient room or environment in the form of hypothetical floor plans.

FIG. 8 sets forth a logical process according to the invention for establishing a set of controls, limits, and configurations for controllable devices in a patient's room or environment.

### SUMMARY OF THE INVENTION

According to a patient role and permissions indicators, an origin safeguard context including a patient origin location identifier, an associated origin space safeguard profile, and at least one associated previously-established set of control parameters, limit settings, and controllable device configurations are reconciled with a patient destination location identifier and an associated destination space safeguard profile to produce a destination safeguard context including a destination location set of control parameters, limit settings, and controllable device configurations. One or more destination facility configurations are controlled according to the destination safeguard context to provide automated portable safeguard contexts of in-room equipment such as patient monitors, gas valves, door locks, light switches, electricity sources, power furniture adjusters, and bedside instruments.

### DETAILED DESCRIPTION OF THE INVENTION

The inventors of the present invention have recognized a problem unaddressed in the art regarding safety conditions in certain areas such as hospital rooms. For the purposes of this disclosure, the present invention will be described relative to an exemplary embodiment applied to hospitals, clinics, and other medical facilities. It will be readily recognized by those skilled in the art that the invention can be utilized for benefit in other environments, as well.

### System Overview

The present invention preferably utilizes a Room Safety Portlet (“RSP”) which cooperates with existing systems commonly found in hospitals, clinics, and medical facilities, such as local area networks, wireless networks, personal computers, personal digital assistants, pagers, cell phones, and patient administrative management systems (e.g. check in/check out systems, record tracking, etc.).

The RSP is a management system that eliminates and reduces the inherent dangers within a hospital environment. This allows user to define safety rules and guidelines. It first determines which equipment can safeguard persons near the equipment, and which equipment has safeguards which can prevent tampering or unauthorized configuration changes.

The system sets role definitions for visitors and occupants, such as a role configured for children of a certain age range, adults of reduced physical or mental capacity, etc. A verification module checks each patient record and includes any debilitating mental disorders or alerts, for example. In addition, its intelligence module takes into account data information for visitors, patients, and room configurations to enable and disable safety features for different scenarios. In case of emergency or system failure, the system preferably incorporates an emergency override capability.

### Building-Level Equipment

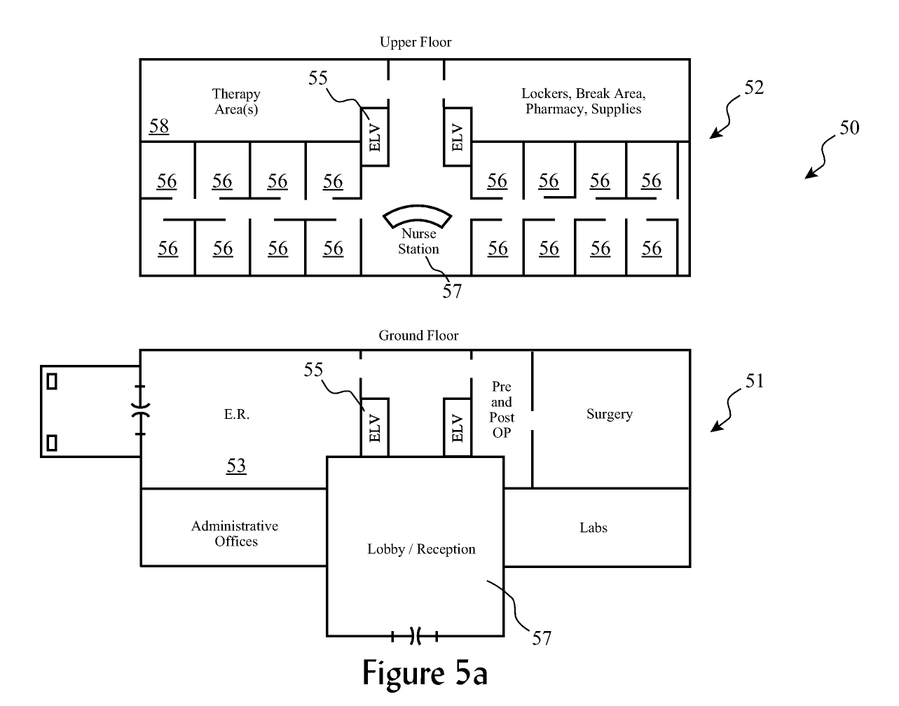

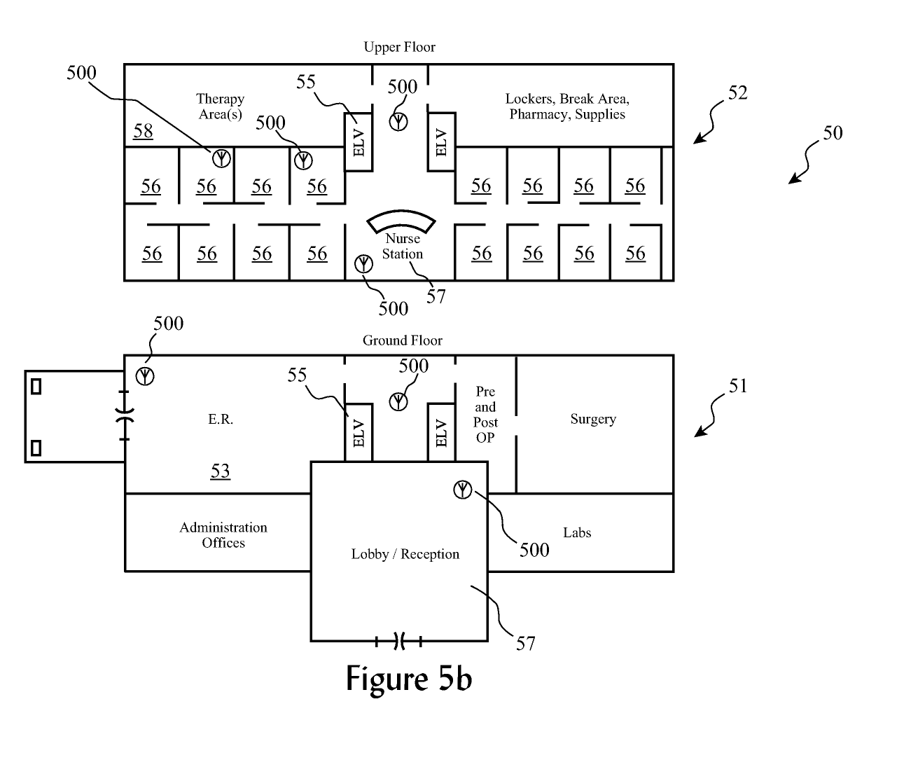

FIG. 5a shows a hypothetical floor plan of a hospital (50), having a ground floor (51), and an upper floor (52). On the ground floor, there is a lobby or reception area (57) for checking in of non-emergency patients, and for visitors to register and receive guidance. There may also be rooms for laboratories, administration offices, a surgery room (52), pre- or post-operative care, and an emergency room (“ER”) (53). Elevators (55) may lead to upper or lower floors.

The upper floor(s) (52) may include therapy areas (58), staff lockers, break areas, pharmacies, and supply storage (59), as well as patient rooms (56), one or more nurses stations (57), and additional labs, surgery areas, etc.

Generally, according to the present methods without the invention, visitors are allowed to move freely from the lobby to the elevators, OR, ER, the patient rooms, or even the labs. However, each of these movements for a visitor (or patient) having reduced mental or physical capacity may present dangers to themselves and others.

So, according to one aspect of one embodiment of the present invention, the building is equipped with one or more Radio Frequency Identification (“RFID”) transponders (500) at key locations throughout the building, as shown for example in FIG. 5b. Alternate wireless technologies, such as Infra Red Data Arrangement (“IrDA”), or even magnetic strip or bar code readers, can be employed similarly. These transponders are placed at key locations to monitor and control the movement of visitors and patients. Patients, and optionally visitors, are provided an appropriate ID device upon registration or check in, and therefore their movements and location can be monitored by a computer system which is interconnected to the transponders. For example, as a patient registers at the lobby, he or she is issued an RFID card, which is immediately detected by the transponder in the lobby. As that person moves to the second floor, his or her location is detected by transponders first in the second floor elevator lobby, then near the nurse station, and finally in a particular patient's room.

Similarly, transponders can be deployed in other hazardous areas, such as factory floors, machine shops, etc.

### Room-Level Equipment

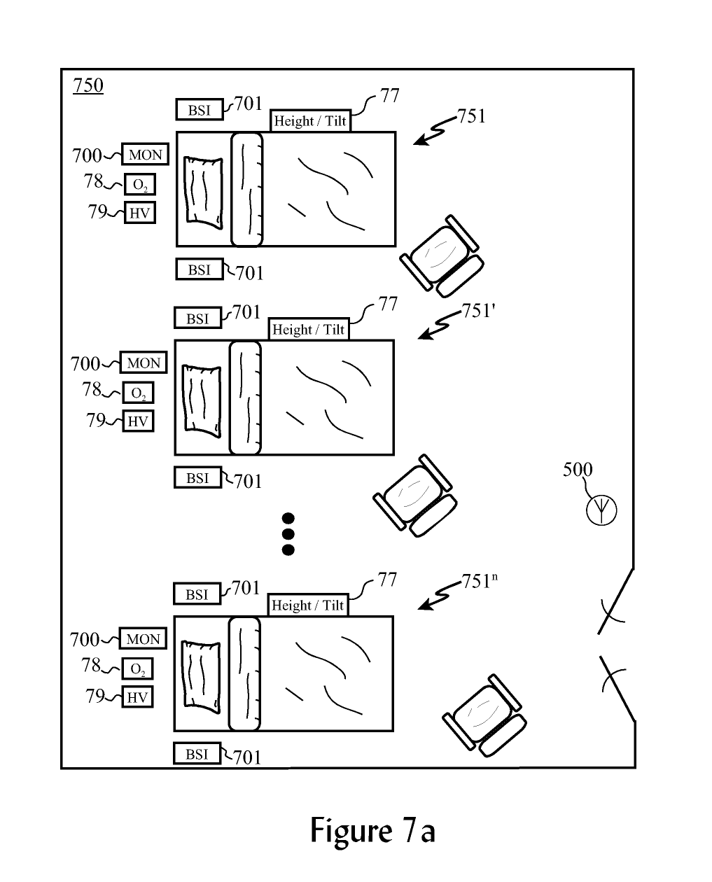

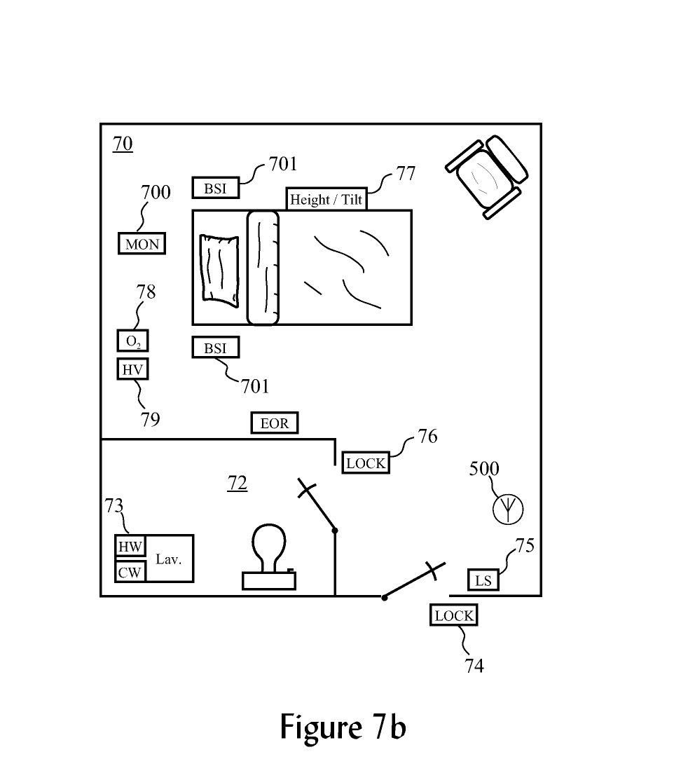

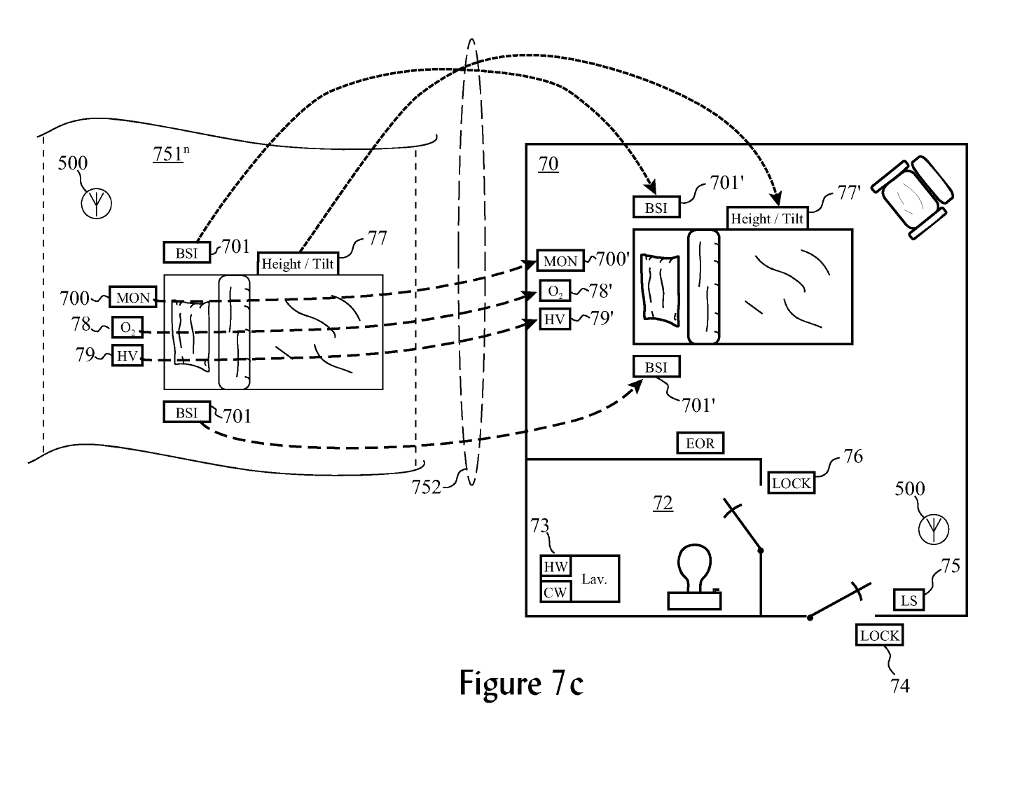

FIG. 7a shows a hypothetical multi-patient hospital room, such as a surgical recovery room or a specially ward, having a plurality n of beds. Each patient area (751, 751′, through 75ⁿ), for example, may be provided a bed (71) having remotely controllable height and tilt adjusters (77), one or more remotely controllable bed side instruments (701) such as IV pumps, one or more remotely controllable monitors (700) such as heart rate and blood pressure monitors, one or more remotely controllable valves (78, 73) such as oxygen valves and hot water valves, one or more remotely controllable voltage sources such as 220 V AC outlets. Additionally, the multi-patient room is preferably provided with ID transponder (500) within the room or near the door of the room.

FIG. 7b similarly illustrates a hypothetical hospital room floor plan, having similar or analogous equipment, and having other controllable devices such as light switches (75), one or more remotely controllable door locks (74) such as a room door lock or lavatory (72) door lock, and an emergency override (“EOR”) switch.

### Information Handling and Control

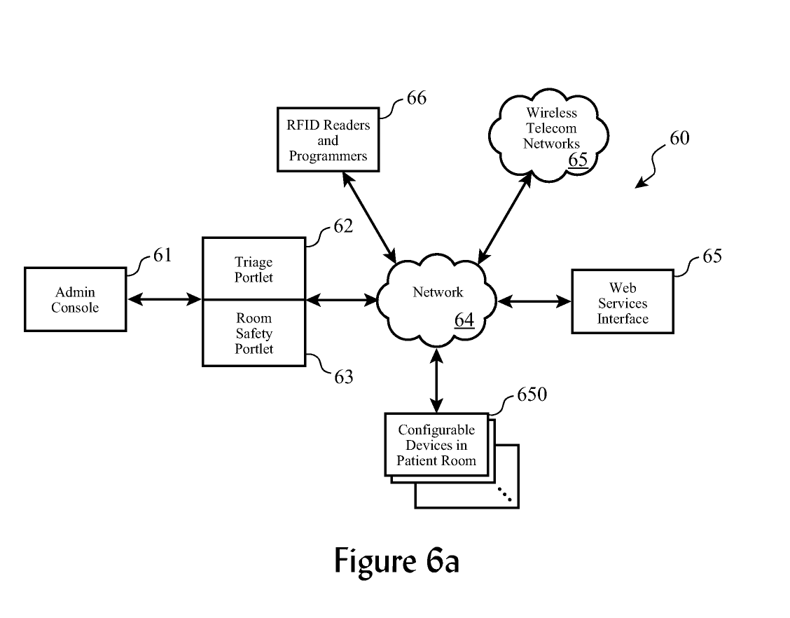

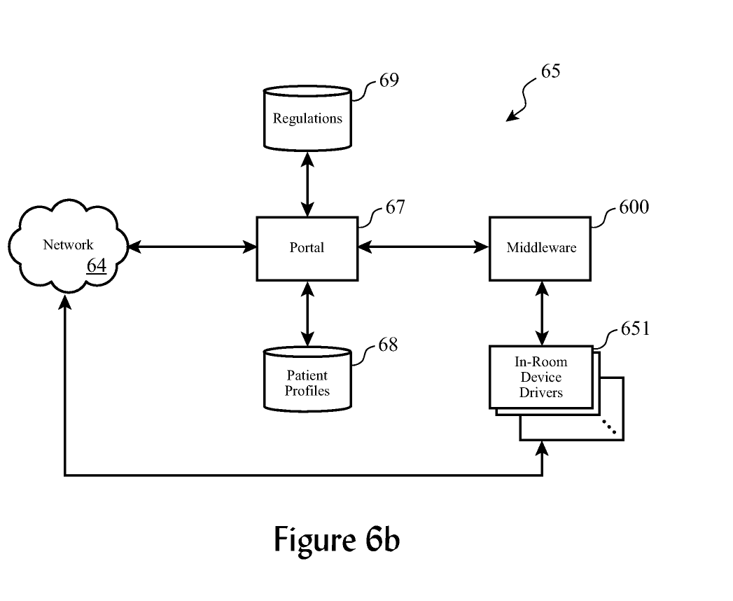

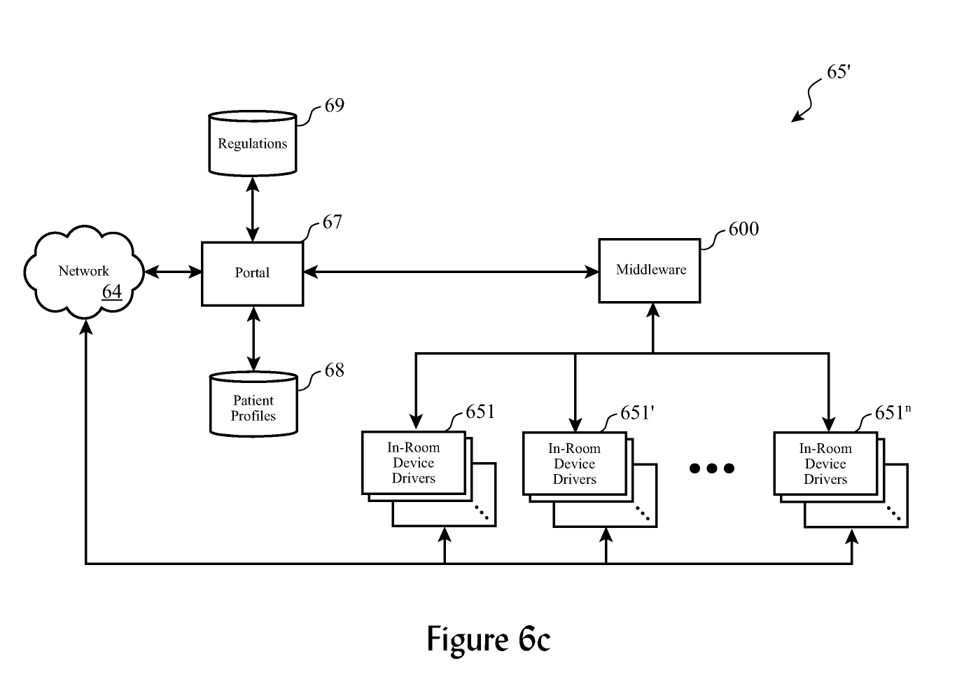

FIG. 6a illustrates one portion (60) of an information technology system according to the present invention. In this arrangement, an administration console (61), such as a networked personal computer, PDA, or cell phone, interfaces to a triage portlet (62), and a room safety portlet (63). Triage portlets are generally well-known in the art as software programs and database applications which allow human operators to register new patients, register visitors, track patient locations and room assignments, see patient status, etc.

Also interconnected via a network (64) such as a LAN or a wireless network, are one or more transponders (66) and/or ID programmers, a web services interface (65), and one or more remotely configurable and controllable devices (650) such as in-room monitors, door locks, gas and water valves, bed adjustment motor controls, etc.

FIG. 6b provides a portion (65) of systems arranged according to the invention including a network (64), and a portal (67) through which regulations (69), such as regional or national regulations can be accessed, as well as patient profiles and preferences (68). These regulations and profiles are preferably stored as electronic data records in one or more electronic databases. Additionally, the portal, using certain business logic modules, interfaces to middleware (600), which in turn communicates with one or more controllable devices (e.g. valves, locks, monitors, motors, etc.) via one or more device drivers (651).

FIG. 6c provides more details (65′) of the arrangement (65) of FIG. 6b, especially showing in-room device drivers for a plurality of rooms (651, 651′, . . . 651ⁿ), controlled by one or more middleware (600) and portals (67) via a network (64).

### Logical Processes

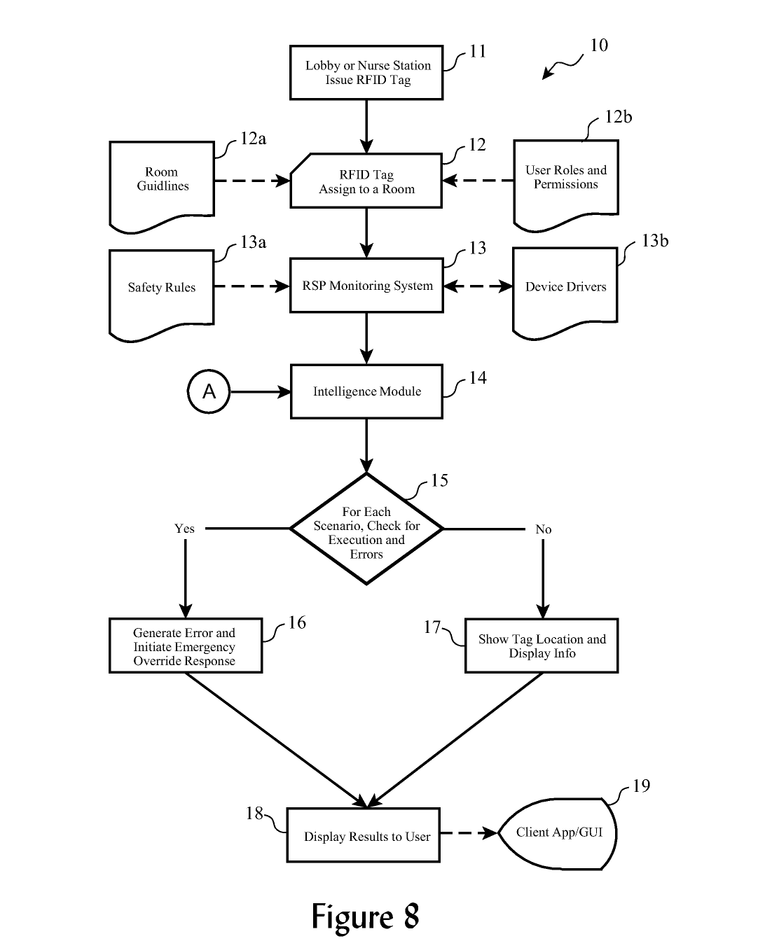

Turning to FIG. 8, a logical process (10) according to the invention is shown. The logical process can be implemented in one or more software modules, run by or integrated to any or all of the aforementioned system components. Upon registration by a patient or a visitor to the building or facility (11), an administrator or nurse issues the patient an ID device, which is associated by the RSP to the person's profile. Additionally, depending on the person's destination (12), room guidelines (12a) and roles and permissions (12b) are consulted.

Next, the RSP utilizes the locating and tracking functions associated with the ID device and transponders to monitor (13) the movement of the person, enabling safety rules (13a) and equipment safeguards via the device drivers (13b, 651) by an intelligence module (14). For example, for a patient having a “young child” profile who is being moved into a room where he or she is to be provided IV medications using a bed side instrument, the front panel of the bed side instrument in the patient's room is locked or disabled from making changes without an override key or password. Additionally, the bed height and tilt motorized controls may be disabled or locked. When the emergency override is activated, these safeguards are disabled, returning the in-room devices to normal operation, for example.

Further, the logical process preferably checks various safeguard scenarios (15) to determine if certain conditions exist which may pose an uncontrollable safety hazard, during which errors may be posted, overrides may be enacted, and current locations of visitors (16) and patients may be monitored (17) or displayed (18, 19).

This process is preferably continually updated and executed while the patient is within the controlled facility.

In this manner, safety precautions are automatically enacted in facilities and equipment as patients are assigned to a controlled space. Drugged or mentally incapacitated patients can be prevented from changing equipment settings, wandering into storage closets, or leaving the facility. Children can be prevented from burns due to hot water, injury due to motorized equipment, and their travels can be limited to prevent accidental poisonings.

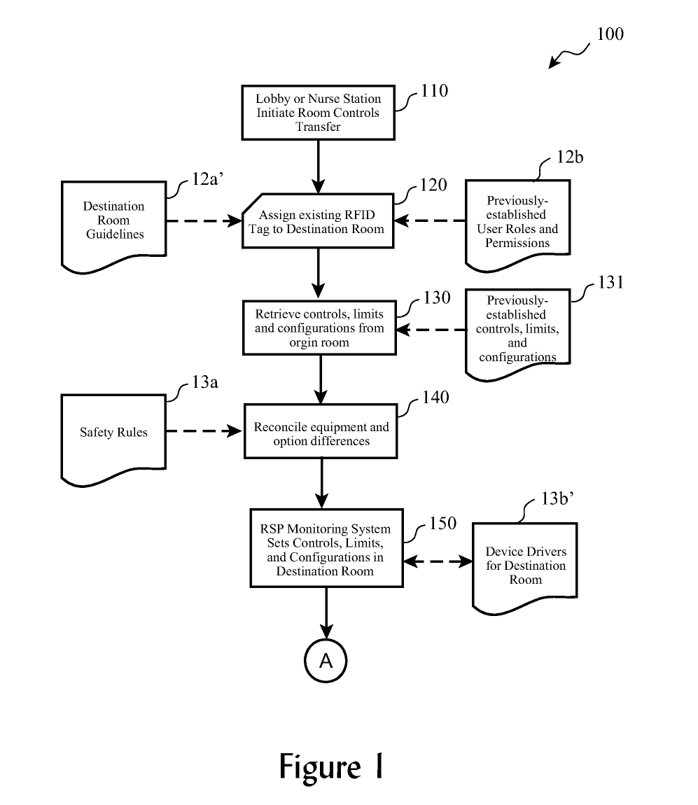

Turning to FIG. 1, a logical process (100) to transfer controls, configurations, and limitations from a first room to a destination room is shown. Using a console or web browser, for example, a nurse or administrator initiates (110) a transfer for the patient from the origin room to the destination room, such as from a surgical recovery ward to a private hospital room. The RFID associated with the patient is assigned (120) to the destination room, and the destination room is provided with its own set of guidelines (12a′). Guidelines may vary from room to room by type of room (e.g. intensive care, surgical recovery, OBGYN delivery, physical therapy, private patient room, etc.), for example.

The patient's previously-established role and permissions (12b) are also retrieved (130), as are the previously-established controls, limits and configurations for the equipment and devices located in the origin room or environment.

Next, the differences between equipment and room guidelines between the origin room and the destination room are reconciled (140), taking into consideration any safety rules and limits (13a) as appropriate, all of which are preferably encoded as business logic modules on a server, database records, or the like. For example, in the origin environment, a first IV pump may be present, while a second IV pump may be present in the destination room. Reconciliation will map any limits or configurations set in the first IV pump to the available controls in the second IV pump. If one or more controls or limits are not settable in the second IV pump, a warning message is preferably generated to the administrator or nurse.

Next, the new set of controls, limits, and configurations are implemented (150) by the invention through the device drivers (13b′) in the destination room, thereby copying or transferring the safeguard context from the first room or environment to the second room or environment.

This transfer (752) is illustrated in a physical (e.g. floorplan) manner in FIG. 7c, wherein the invention automatically transfers the controls, limits, and configurations when appropriate and in a analogous manner between various equipment and devices from the origin environment to the destination environment.

### Suitable Computing Platform

In one embodiment of the invention, the functionality of the safeguard tracking system, including the previously described logical processes, are performed in part or wholly by software executed by a computer, such as personal computers, web servers, web browsers, or even an appropriately capable portable computing platform, such as personal digital assistant (“PDA”), web-enabled wireless telephone, or other type of personal information management (“PIM”) device.

Therefore, it is useful to review a generalized architecture of a computing platform which may span the range of implementation, from a high-end web or enterprise server platform, to a personal computer, to a portable PDA or web-enabled wireless phone.

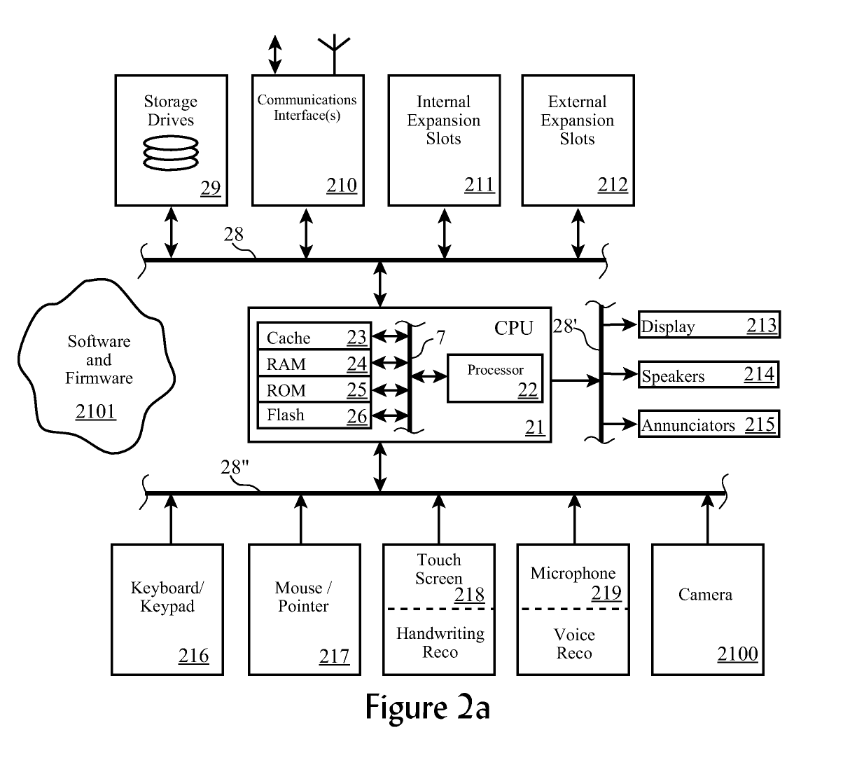

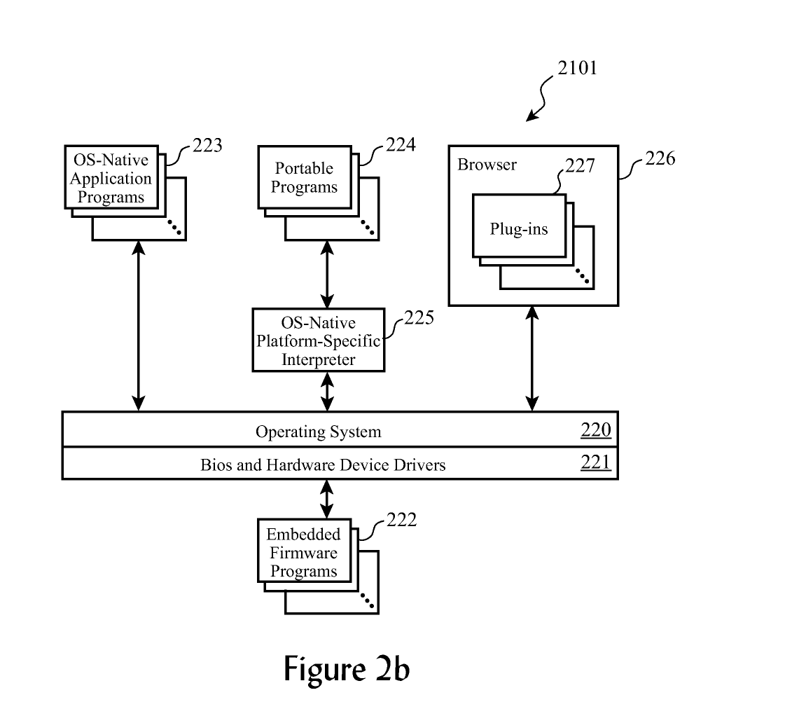

Turning to FIG. 2a, a generalized architecture is presented including a central processing unit (21) (“CPU”), which is typically comprised of a microprocessor (22) associated with random access memory (“RAM”) (24) and read-only memory (“ROM”) (25). Often, the CPU (21) is also provided with cache memory (23) and programmable FlashROM (26). The interface (27) between the microprocessor (22) and the various types of CPU memory is often referred to as a “local bus”, but also may be a more generic or industry standard bus.

Many computing platforms are also provided with one or more storage drives (29), such as hard-disk drives (“HDD”), floppy disk drives, compact disc drives (CD, CD-R, CD-RW, DVD, DVD-R, etc.), and proprietary disk and tape drives (e.g., Tomega Zip™ and Jaz™, Addonics SuperDisk™, etc.). Additionally, some storage drives may be accessible over a computer network.

Many computing platforms are provided with one or more communication interfaces (210), according to the function intended of the computing platform. For example, a personal computer is often provided with a high speed serial port (RS-232, RS-422, etc.), an enhanced parallel port (“EPP”), and one or more universal serial bus (“USB”) ports. The computing platform may also be provided with a local area network (“LAN”) interface, such as an Ethernet card, and other high-speed interfaces such as the High Performance Serial Bus IEEE-1394.

Computing platforms such as wireless telephones and wireless networked PDA's may also be provided with a radio frequency (“RF”) interface with antenna, as well. In some cases, the computing platform may be provided with an infrared data arrangement (“IrDA”) interface, too.

Computing platforms are often equipped with one or more internal expansion slots (211), such as Industry Standard Architecture (“ISA”), Enhanced Industry Standard Architecture (“EISA”), Peripheral Component Interconnect (“PCI”), or proprietary interface slots for the addition of other hardware, such as sound cards, memory boards, and graphics accelerators.

Additionally, many units, such as laptop computers and PDA's, are provided with one or more external expansion slots (212) allowing the user the ability to easily install and remove hardware expansion devices, such as PCMCIA cards, SmartMedia cards, and various proprietary modules such as removable hard drives, CD drives, and floppy drives.

Often, the storage drives (29), communication interfaces (210), internal expansion slots (211) and external expansion slots (212) are interconnected with the CPU (21) via a standard or industry open bus architecture (28), such as ISA, EISA, or PCI. In many cases, the bus (28) may be of a proprietary design.

A computing platform is usually provided with one or more user input devices, such as a keyboard or a keypad (216), and mouse or pointer device (217), and/or a touch-screen display (218). In the case of a personal computer, a full size keyboard is often provided along with a mouse or pointer device, such as a track ball or TrackPoint™. In the case of a web-enabled wireless telephone, a simple keypad may be provided with one or more function-specific keys. In the case of a PDA, a touch-screen (218) is usually provided, often with handwriting recognition capabilities.

Additionally, a microphone (219), such as the microphone of a web-enabled wireless telephone or the microphone of a personal computer, is supplied with the computing platform. This microphone may be used for simply reporting audio and voice signals, and it may also be used for entering user choices, such as voice navigation of web sites or auto-dialing telephone numbers, using voice recognition capabilities.

Many computing platforms are also equipped with a camera device (2100), such as a still digital camera or full motion video digital camera.

One or more user output devices, such as a display (213), are also provided with most computing platforms. The display (213) may take many forms, including a Cathode Ray Tube (“CRT”), a Thin Flat Transistor (“TFT”) array, or a simple set of light emitting diodes (“LED”) or liquid crystal display (“LCD”) indicators.

One or more speakers (214) and/or annunciators (215) are often associated with computing platforms, too. The speakers (214) may be used to reproduce audio and music, such as the speaker of a wireless telephone or the speakers of a personal computer. Annunciators (215) may take the form of simple beep emitters or buzzers, commonly found on certain devices such as PDAs and PIMs.

These user input and output devices may be directly interconnected (28′, 28″) to the CPU (21) via a proprietary bus structure and/or interfaces, or they may be interconnected through one or more industry open buses such as ISA, EISA, PCI, etc.

The computing platform is also provided with one or more software and firmware (2101) programs to implement the desired functionality of the computing platforms.

Turning to now FIG. 2b, more detail is given of a generalized organization of software and firmware (2101) on this range of computing platforms. One or more operating system (“OS”) native application programs (223) may be provided on the computing platform, such as word processors, spreadsheets, contact management utilities, address book, calendar, email client, presentation, financial and bookkeeping programs.

Additionally, one or more “portable” or device-independent programs (224) may be provided, which must be interpreted by an OS-native platform-specific interpreter (225), such as Java™ scripts and programs.

Often, computing platforms are also provided with a form of web browser or micro-browser (226), which may also include one or more extensions to the browser such as browser plug-ins (227).

The computing device is often provided with an operating system (220), such as Microsoft Windows™, UNIX, IBM OS/2™, IBM AIX™, open source LINUX, Apple's MAC OS™, or other platform specific operating systems. Smaller devices such as PDA's and wireless telephones may be equipped with other forms of operating systems such as real-time operating systems (“RTOS”) or Palm Computing's PalmOS™.

A set of basic input and output functions (“BIOS”) and hardware device drivers (221) are often provided to allow the operating system (220) and programs to interface to and control the specific hardware functions provided with the computing platform.

Additionally, one or more embedded firmware programs (222) are commonly provided with many computing platforms, which are executed by onboard or “embedded” microprocessors as part of the peripheral device, such as a micro controller or a hard drive, a communication processor, network interface card, or sound or graphics card.

As such, FIGS. 2a and 2b describe in a general sense the various hardware components, software and firmware programs of a wide variety of computing platforms, including but not limited to personal computers, PDAs, PIMs, web-enabled telephones, and other appliances such as WebTV™ units. As such, we now turn our attention to disclosure of the present invention relative to the processes and methods preferably implemented as software and firmware on such a computing platform. It will be readily recognized by those skilled in the art that the following methods and processes may be alternatively realized as hardware functions, in part or in whole, without departing from the spirit and scope of the invention.

### Service-Based Embodiments

Alternative embodiments of the present invention include some or all of the foregoing logical processes and functions of the invention being provided by configuring software, deploying software, downloading software, distributing software, or remotely serving clients in an on demand environment.

Software Deployment Embodiment. According to one embodiment of the invention, the methods and processes of the invention are distributed or deployed as a service by a service provider to a client's computing system(s).

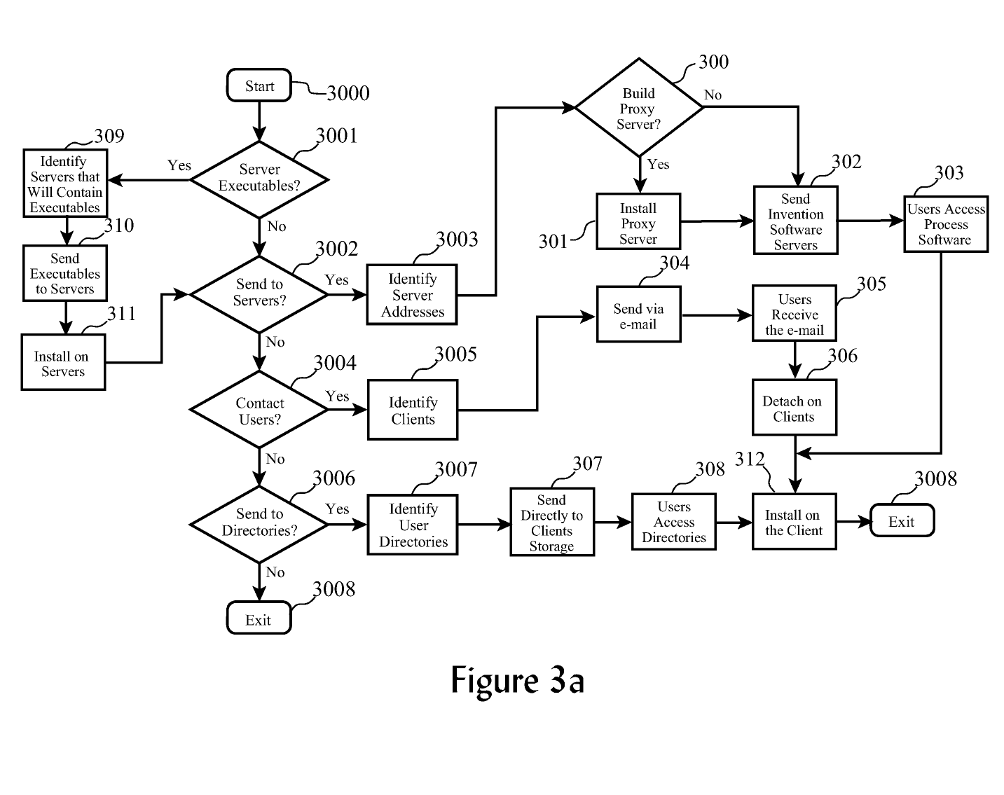

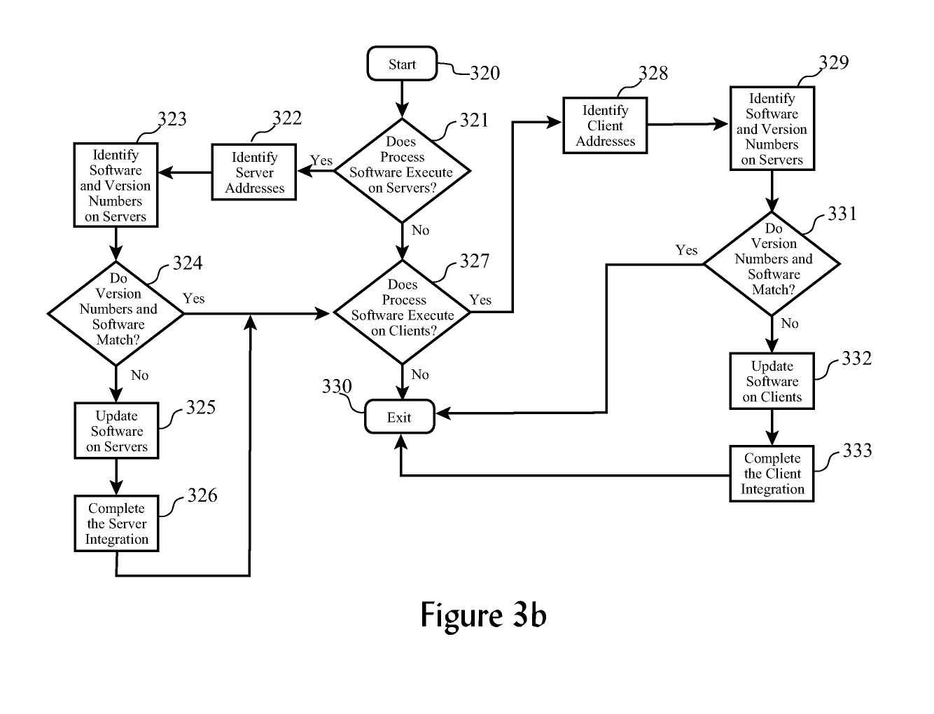

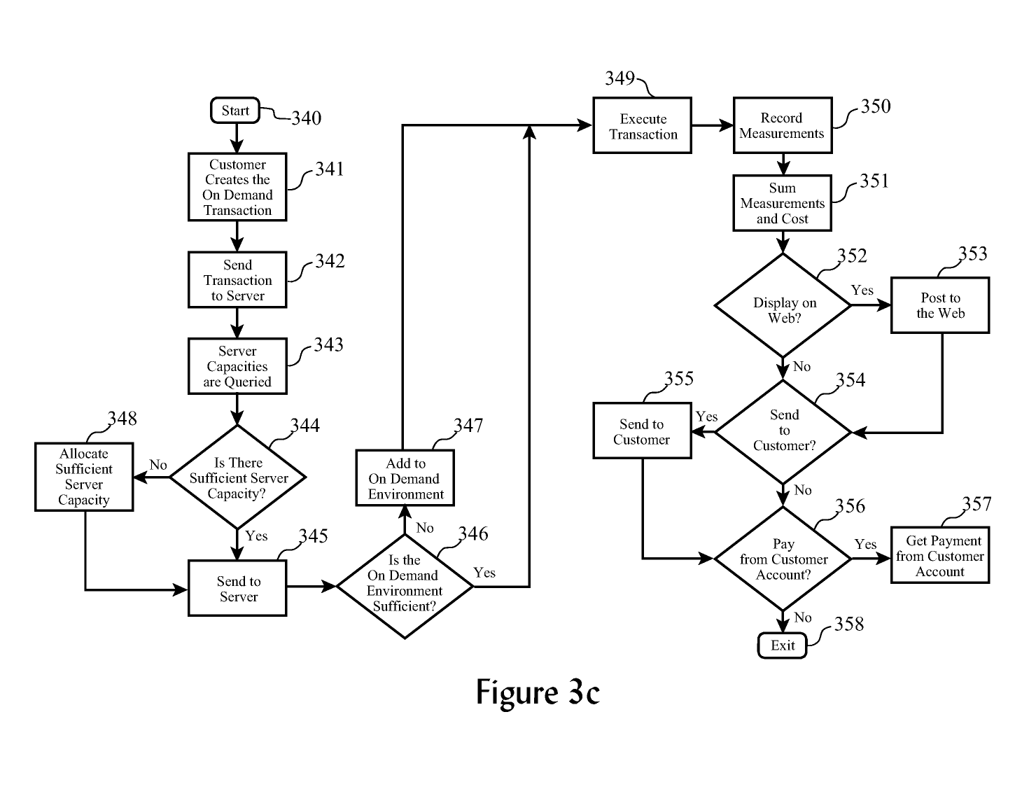

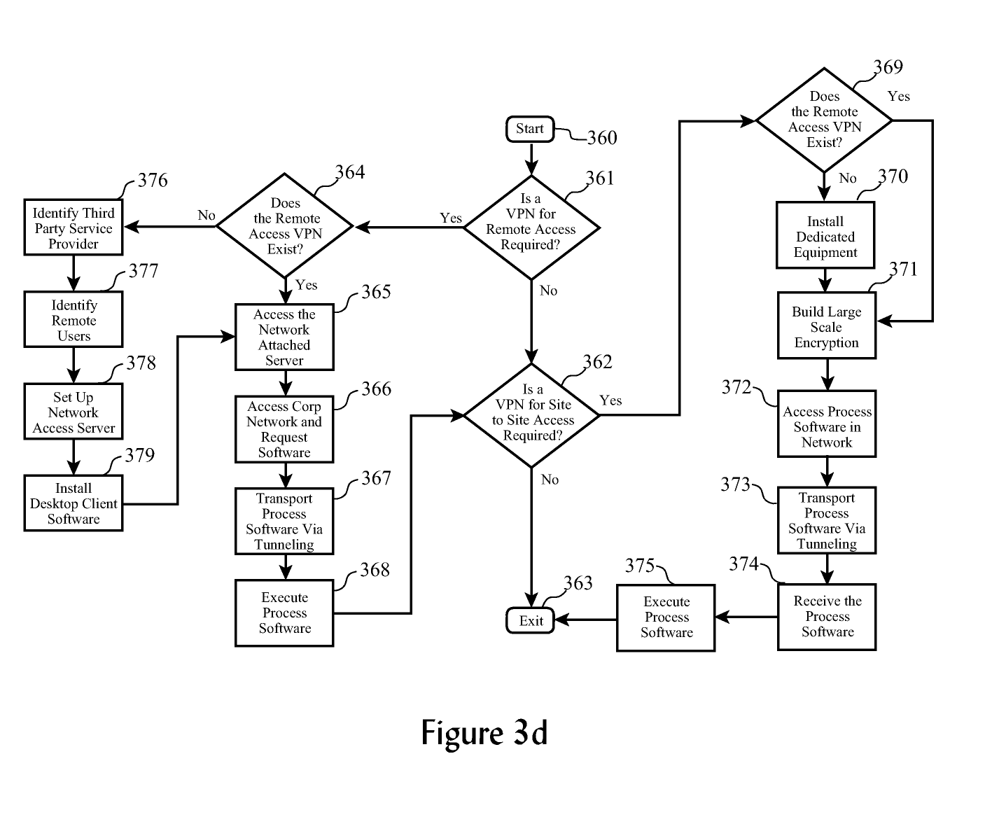

Turning to FIG. 3a, the deployment process begins (3000) by determining (3001) if there are any programs that will reside on a server or servers when the process software is executed. If this is the case, then the servers that will contain the executables are identified (309). The process software for the server or servers is transferred directly to the servers storage via FTP or some other protocol or by copying through the use of a shared files system (310). The process software is then installed on the servers (311).

Next a determination is made on whether the process software is to be deployed by having users access the process software on a server or servers (3002). If the users are to access the process software on servers, then the server addresses that will store the process software are identified (3003).

In step (3004) a determination is made whether the process software is to be developed by sending the process software to users via e-mail. The set of users where the process software will be deployed are identified together with the addresses of the user client computers (3005). The process software is sent via e-mail to each of the user's client computers. The users then receive the e-mail (305) and then detach the process software from the e-mail to a directory on their client computers (306). The user executes the program that installs the process software on his client computer (312) then exits the process (3008).

A determination is made if a proxy server is to be built (300) to store the process software. A proxy server is a server that sits between a client application, such as a Web browser, and a real server. It intercepts all requests to the real server to see if it can fulfill the requests itself. If not, it forwards the request to the real server. The two primary benefits of a proxy server are to improve performance and to filter requests. If a proxy server is required then the proxy server is installed (301). The process software is sent to the servers either via a protocol such as FTP or it is copied directly from the source files to the server files via file sharing (302). Another embodiment would be to send a transaction to the servers that contained the process software and have the server process the transaction, then receive and copy the process software to the server's file system. Once the process software is stored at the servers, the users via their client computers, then access the process software on the servers and copy to their client computers file systems (303). Another embodiment is to have the servers automatically copy the process software to each client and then run the installation program for the process software at each client computer. The user executes the program that installs the process software on his client computer (312) then exits the process (3008).

Lastly, a determination is made on whether the process software will be sent directly to user directories on their client computers (3006). If so, the user directories are identified (3007). The process software is transferred directly to the user's client computer directory (307). This can be done in several ways such as, but not limited to, sharing of the file system directories and then copying from the sender's file system to the recipient user's file system or alternatively using a transfer protocol such as File Transfer Protocol (“FTP”). The users access the directories on their client file systems in preparation for installing the process software (308). The user executes the program that installs the process software on his client computer (312) then exits the process (3008).

Software Integration Embodiment. According to another embodiment of the present invention, software embodying the methods and processes disclosed herein are integrated as a service by a service provider to other software applications, applets, or computing systems.

Integration of the invention generally includes providing for the process software to coexist with applications, operating systems and network operating systems software and then installing the process software on the clients and servers in the environment where the process software will function.

Generally speaking, the first task is to identify any software on the clients and servers including the network operating system where the process software will be deployed that are required by the process software or that work in conjunction with the process software. This includes the network operating system that is software that enhances a basic operating system by adding networking features. Next, the software applications and version numbers will be identified and compared to the list of software applications and version numbers that have been tested to work with the process software. Those software applications that are missing or that do not match the correct version will be upgraded with the correct version numbers. Program instructions that pass parameters from the process software to the software applications will be checked to ensure the parameter lists matches the parameter lists required by the process software. Conversely parameters passed by the software applications to the process software will be checked to ensure the parameters match the parameters required by the process software. The client and server operating systems including the network operating systems will be identified and compared to the list of operating systems, version numbers and network software that have been tested to work with the process software. Those operating systems, version numbers and network software that do not match the list of tested operating systems and version numbers will be upgraded on the clients and servers to the required level.

After ensuring that the software, where the process software is to be deployed, is at the correct version level that has been tested to work with the process software, the integration is completed by installing the process software on the clients and servers.

Turning to FIG. 3b, details of the integration process according to the invention are shown. Integrating begins (320) by determining if there are any process software programs that will execute on a server or servers (321). If this is not the case, then integration proceeds to (327). If this is the case, then the server addresses are identified (322). The servers are checked to see if they contain software that includes the operating system (“OS”), applications, and network operating systems (“NOS”), together with their version numbers, that have been tested with the process software (323). The servers are also checked to determine if there is any missing software that is required by the process software (323).

A determination is made if the version numbers match the version numbers of OS, applications and NOS that have been tested with the process software (324). If all of the versions match and there is no missing required software the integration continues in (327).

If one or more of the version numbers do not match, then the unmatched versions are updated on the server or servers with the correct versions (325). Additionally, if there is missing required software, then it is updated on the server or servers (325). The server integration is completed by installing the process software (326).

Step (327) which follows either (321), (324), or (326) determines if there are any programs of the process software that will execute on the clients. If no process software programs execute on the clients, the integration proceeds to (330) and exits. If this is not the case, then the client addresses are identified (328).

The clients are checked to see if they contain software that includes the operating system (“OS”), applications, and network operating systems (“NOS”), together with their version numbers, that have been tested with the process software (329). The clients are also checked to determine if there is any missing software that is required by the process software (329).

A determination is made if the version numbers match the version numbers of OS, applications and NOS that have been tested with the process software 331. If all of the versions match and there is no missing required software, then the integration proceeds to (330) and exits.

If one or more of the version numbers do not match, then the unmatched versions are updated on the clients with the correct versions (332). In addition, if there is missing required software then it is updated on the clients (332). The client integration is completed by installing the process software on the clients (333). The integration proceeds to (330) and exits.

Application Programming Interface Embodiment. In another embodiment, the invention may be realized as a service or functionality available to other systems and devices via an Application Programming Interface (“API”). One such embodiment is to provide the service to a client system from a server system as a web service.

On-Demand Computing Services Embodiment. According to another aspect of the present invention, the processes and methods disclosed herein are provided through an on demand computing architecture to render service to a client by a service provider.

Turning to FIG. 3c, generally speaking, the process software embodying the methods disclosed herein is shared, simultaneously serving multiple customers in a flexible, automated fashion. It is standardized, requiring little customization and it is scaleable, providing capacity on demand in a pay-as-you-go model.

The process software can be stored on a shared file system accessible from one or more servers. The process software is executed via transactions that contain data and server processing requests that use CPU units on the accessed server. CPU units are units of time such as minutes, seconds, hours on the central processor of the server. Additionally, the assessed server may make requests of other servers that require CPU units. CPU units are an example that represents but one measurement of use. Other measurements of use include but are not limited to network bandwidth, memory usage, storage usage, packet transfers, complete transactions, etc.

When multiple customers use the same process software application, their transactions are differentiated by the parameters included in the transactions that identify the unique customer and the type of service for that customer. All of the CPU units and other measurements of use that are used for the services for each customer are recorded. When the number of transactions to any one server reaches a number that begins to effect the performance of that server, other servers are accessed to increase the capacity and to share the workload. Likewise, when other measurements of use such as network bandwidth, memory usage, storage usage, etc. approach a capacity so as to effect performance, additional network bandwidth, memory usage, storage etc. are added to share the workload.

The measurements of use used for each service and customer are sent to a collecting server that sums the measurements of use for each customer for each service that was processed anywhere in the network of servers that provide the shared execution of the process software. The summed measurements of use units are periodically multiplied by unit costs and the resulting total process software application service costs are alternatively sent to the customer and or indicated on a web site accessed by the computer which then remits payment to the service provider.

In another embodiment, the service provider requests payment directly from a customer account at a banking or financial institution.

In another embodiment, if the service provider is also a customer of the customer that uses the process software application, the payment owed to the service provider is reconciled to the payment owed by the service provider to minimize the transfer of payments.

FIG. 3c sets forth a detailed logical process which makes the present invention available to a client through an On-Demand process. A transaction is created that contains the unique customer identification, the requested service type and any service parameters that further specify the type of service (341). The transaction is then sent to the main server (342). In an On-Demand environment the main server can initially be the only server, then as capacity is consumed other servers are added to the On-Demand environment.

The server central processing unit (“CPU”) capacities in the On-Demand environment are queried (343). The CPU requirement of the transaction is estimated, then the servers available CPU capacity in the On-Demand environment are compared to the transaction CPU requirement to see if there is sufficient CPU available capacity in any server to process the transaction (344). If there is not sufficient server CPU available capacity, then additional server CPU capacity is allocated to process the transaction (348). If there was already sufficient available CPU capacity, then the transaction is sent to a selected server (345).

Before executing the transaction, a check is made of the remaining On-Demand environment to determine if the environment has sufficient available capacity for processing the transaction. This environment capacity consists of such things as, but not limited to, network bandwidth, processor memory, storage etc.

(345). If there is not sufficient available capacity, then capacity will be added to the On-Demand environment (347). Next, the required software to process the transaction is accessed, loaded into memory, then the transaction is executed (349).

The usage measurements are recorded (350). The usage measurements consists of the portions of those functions in the On-Demand environment that are used to process the transaction. The usage of such functions as, but not limited to, network bandwidth, processor memory, storage and CPU cycles are what is recorded. The usage measurements are summed, multiplied by unit costs and then recorded as a charge to the requesting customer (351).

If the customer has requested that the On-Demand costs be posted to a web site (352), then they are posted (353). If the customer has requested that the On-Demand costs be sent via e-mail to a customer address (354), then they are sent (355). If the customer has requested that the On-Demand costs be paid directly from a customer account (356), then payment is received directly from the customer account (357). The last step is to exit the On-Demand process.

Grid or Parallel Processing Embodiment. According to another embodiment of the present invention, multiple computers are used to simultaneously process individual audio tracks, individual audio snippets, or a combination of both, to yield output with less delay. Such a parallel computing approach may be realized using multiple discrete systems (e.g. a plurality of servers, clients, or both), or may be realized as an internal multiprocessing task (e.g. a single system with parallel processing capabilities).

VPN Deployment Embodiment. According to another aspect of the present invention, the methods and processes described herein may be embodied in part or in entirety in software which can be deployed to third parties as part of a service, wherein a third party VPN service is offered as a secure deployment vehicle or wherein a VPN is build on-demand as required for a specific deployment.

A virtual private network (“VPN”) is any combination of technologies that can be used to secure a connection through an otherwise unsecured or untrusted network. VPNs improve security and reduce operational costs. The VPN makes use of a public network, usually the Internet, to connect remote sites or users together. Instead of using a dedicated, real-world connection such as leased line, the VPN uses “virtual” connections routed through the Internet from the company's private network to the remote site or employee. Access to the software via a VPN can be provided as a service by specifically constructing the VPN for purposes of delivery or execution of the process software (i.e. the software resides elsewhere) wherein the lifetime of the VPN is limited to a given period of time or a given number of deployments based on an amount paid.

The process software may be deployed, accessed and executed through either a remote-access or a site-to-site VPN. When using the remote-access VPNs the process software is deployed, accessed and executed via the secure, encrypted connections between a company's private network and remote users through a third-party service provider. The enterprise service provider (“ESP”) sets a network access server (“NAS”) and provides the remote users with desktop client software for their computers. The telecommuters can then dial a toll-free number to attach directly via a cable or DSL modem to reach the NAS and use their VPN client software to access the corporate network and to access, download and execute the process software.

When using the site-to-site VPN, the process software is deployed, accessed and executed through the use of dedicated equipment and large-scale encryption that are used to connect a company's multiple fixed sites over a public network such as the Internet.

The process software is transported over the VPN via tunneling which is the process of placing an entire packet within another packet and sending it over the network. The protocol of the outer packet is understood by the network and both points, called tunnel interfaces, where the packet enters and exits the network.

Turning to FIG. 3d, VPN deployment process starts (360) by determining if a VPN for remote access is required (361). If it is not required, then proceed to (362). If it is required, then determine if the remote access VPN exits (364).

If a VPN does exist, then the VPN deployment process proceeds (365) to identify a third party provider that will provide the secure, encrypted connections between the company's private network and the company's remote users (376). The company's remote users are identified (377). The third party provider then sets up a network access server (“NAS”) (378) that allows the remote users to dial a toll free number or attach directly via a broadband modem to access, download and install the desktop client software for the remote-access VPN (379).

After the remote access VPN has been built or if it has been previously installed, the remote users can access the process software by dialing into the NAS or attaching directly via a cable or DSL modem into the NAS (365). This allows entry into the corporate network where the process software is accessed (366). The process software is transported to the remote user's desktop over the network via tunneling. That is the process software is divided into packets and each packet including the data and protocol is placed within another packet (367). When the process software arrives at the remote user's desktop, it is removed from the packets, reconstituted and then is executed on the remote users desktop (368).

A determination is made to see if a VPN for site to site access is required (362). If it is not required, then proceed to exit the process (363). Otherwise, determine if the site to site VPN exists (369). If it does exist, then proceed to (372). Otherwise, install the dedicated equipment required to establish a site to site VPN (370). Then, build the large scale encryption into the VPN (371).

After the site to site VPN has been built or if it had been previously established, the users access the process software via the VPN (372). The process software is transported to the site users over the network via tunneling. That is the process software is divided into packets and each packet including the data and protocol is placed within another packet (374). When the process software arrives at the remote user's desktop, it is removed from the packets, reconstituted and is executed on the site users desktop (375). Proceed to exit the process (363).

### Computer-Readable Media Embodiments

In another embodiment of the invention, logical processes according to the invention and described herein are encoded on or in one or more computer-readable media. Some computer-readable media are read-only (e.g. they must be initially programmed using a different device than that which is ultimately used to read the data from the media), some are write-only (e.g. from the data encoders perspective they can only be encoded, but not read simultaneously), or read-write. Still some other media are write-once, read-many-times.

Some media are relatively fixed in their mounting mechanisms, while others are removable, or even transmittable. All computer-readable media form two types of systems when encoded with data and/or computer software: (a) when removed from a drive or reading mechanism, they are memory devices which generate useful data-driven outputs when stimulated with appropriate electromagnetic, electronic, and/or optical signals; and (b) when installed in a drive or reading device, they form a data repository system accessible by a computer.

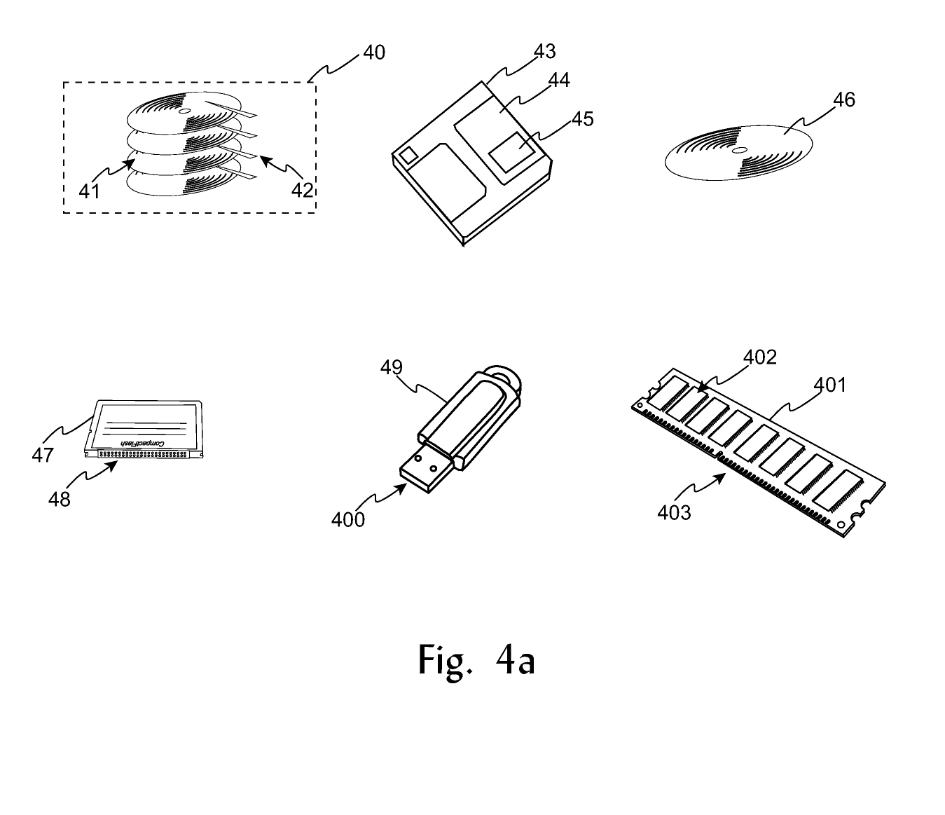

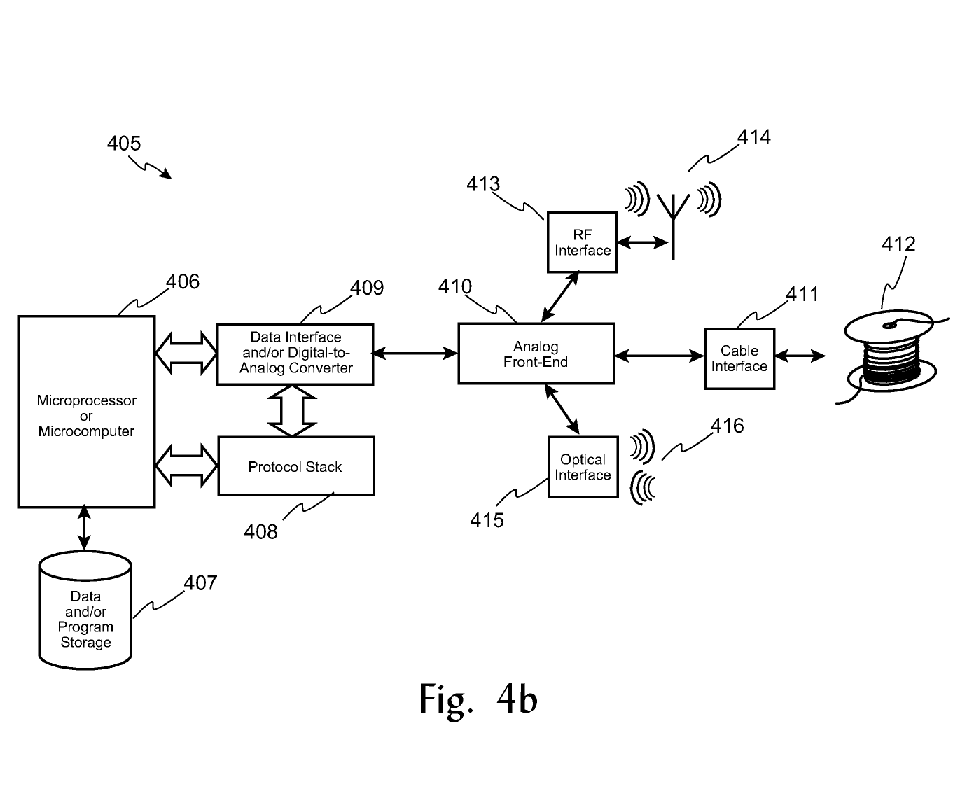

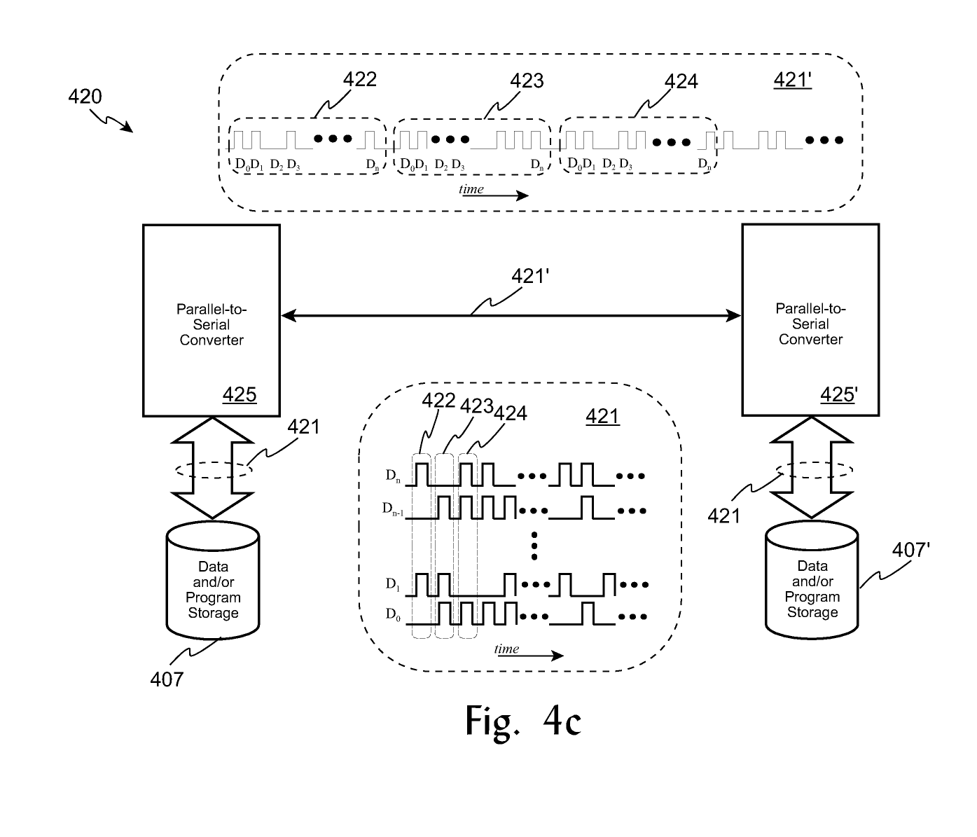

FIG. 4a illustrates some computer readable media including a computer hard drive (40) having one or more magnetically encoded platters or disks (41), which may be read, written, or both, by one or more heads (42). Such hard drives are typically semi-permanently mounted into a complete drive unit, which may then be integrated into a configurable computer system such as a Personal Computer, Server Computer, or the like.

Similarly, another form of computer readable media is a flexible, removable “floppy disk” (43), which is inserted into a drive which houses an access head. The floppy disk typically includes a flexible, magnetically encodable disk which is accessible by the drive head through a window (45) in a sliding cover (44).

A Compact Disk (“CD”) (46) is usually a plastic disk which is encoded using an optical and/or magneto-optical process, and then is read using generally an optical process. Some CD's are read-only (“CD-ROM”), and are mass produced prior to distribution and use by reading-types of drives. Other CD's are writable (e.g. “CD-RW”, “CD-R”), either once or many time. Digital Versatile Disks (“DVD”) are advanced versions of CD's which often include double-sided encoding of data, and even multiple layer encoding of data. Like a floppy disk, a CD or DVD is a removable media.

Another common type of removable media are several types of removable circuit-based (e.g. solid state) memory devices, such as Compact Flash (“CF”) (47), Secure Data (“SD”), Sony's MemoryStick, Universal Serial Bus (“USB”) FlashDrives and “Thumbdrives” (49), and others. These devices are typically plastic housings which incorporate a digital memory chip, such as a battery-backed random access chip (“RAM”), or a Flash Read-Only Memory (“FlashROM”). Available to the external portion of the media is one or more electronic connectors (48, 400) for engaging a connector, such as a CF drive slot or a USB slot. Devices such as a USB FlashDrive are accessed using a serial data methodology, where other devices such as the CF are accessed using a parallel methodology. These devices often offer faster access times than disk-based media, as well as increased reliability and decreased susceptibility to mechanical shock and vibration. Often, they provide less storage capability than comparably priced disk-based media.

Yet another type of computer readable media device is a memory module (403), often referred to as a SIMM or DIMM. Similar to the CF, SD, and FlashDrives, these modules incorporate one or more memory devices (402), such as Dynamic RAM (“DRAM”), mounted on a circuit board (401) having one or more electronic connectors for engaging and interfacing to another circuit, such as a Personal Computer motherboard. These types of memory modules are not usually encased in an outer housing, as they are intended for installation by trained technicians, and are generally protected by a larger outer housing such as a Personal Computer chassis.

Turning now to FIG. 4b, another embodiment option (405) of the present invention is shown in which a computer-readable signal is encoded with software, data, or both, which implement logical processes according to the invention. FIG. 4b is generalized to represent the functionality of wireless, wired, electro-optical, and optical signaling systems. For example, the system shown in FIG. 4b can be realized in a manner suitable for wireless transmission over Radio Frequencies (“RF”), as well as over optical signals, such as InfraRed Data Arrangement (“IrDA”). The system of FIG. 4b may also be realized in another manner to serve as a data transmitter, data receiver, or data transceiver for a USB system, such as a drive to read the aforementioned USB FlashDrive, or to access the serially-stored data on a disk, such as a CD or hard drive platter.

In general, a microprocessor or microcontroller (406) reads, writes, or both, data to/from storage for data, program, or both (407). A data interface (409), optionally including a digital-to-analog converter, cooperates with an optional protocol stack (408), to send, receive, or transceive data between the system front-end (410) and the microprocessor (406). The protocol stack is adapted to the signal type being sent, received, or transceived. For example, in a Local Area Network (“LAN”) embodiment, the protocol stack may implement Transmission Control Protocol/Internet Protocol (“TCP/IP”). In a computer-to-computer or computer-to-periperal embodiment, the protocol stack may implement all or portions of USB, “FireWire”, RS-232, Point-to-Point Protocol (“PPP”), etc.

The system's front-end, or analog front-end, is adapted to the signal type being modulated, demodulate, or transcoded. For example, in an RF-based (413) system, the analog front-end comprises various local oscillators, modulators, demodulators, etc., which implement signaling formats such as Frequency Modulation (“FM”), Amplitude Modulation (“AM”), Phase Modulation (“PM”), Pulse Code Modulation (“PCM”), etc. Such an RF-based embodiment typically includes an antenna (414) for transmitting, receiving, or transceiving electromagnetic signals via open air, water, earth, or via RF wave guides and coaxial cable. Some common open air transmission standards are BlueTooth, Global Services for Mobile Communications (“GSM”), Time Division Multiple Access (“TDMA”), Advanced Mobile Phone Service (“AMPS”), and Wireless Fidelity (“Wi-Fi”).

In another example embodiment, the analog front-end may be adapted to sending, receiving, or transceiving signals via an optical interface (415), such as laser-based optical interfaces (e.g. Wavelength Division Multiplexed, SONET, etc.), or Infra Red Data Arrangement (“IrDA”) interfaces (416). Similarly, the analog front-end may be adapted to sending, receiving, or transceiving signals via cable (412) using a cable interface, which also includes embodiments such as USB, Ethernet, LAN, twisted-pair, coax, Plain-old Telephone Service (“POTS”), etc.

Signals transmitted, received, or transceived, as well as data encoded on disks or in memory devices, may be encoded to protect it from unauthorized decoding and use. Other types of encoding may be employed to allow for error detection, and in some cases, correction, such as by addition of parity bits or Cyclic Redundancy Codes (“CRC”). Still other types of encoding may be employed to allow directing or “routing” of data to the correct destination, such as packet and frame-based protocols.

FIG. 4c illustrates conversion systems which convert parallel data to and from serial data. Parallel data is most often directly usable by microprocessors, often formatted in 8-bit wide bytes, 16-bit wide words, 32-bit wide double words, etc. Parallel data can represent executable or interpretable software, or it may represent data values, for use by a computer. Data is often serialized in order to transmit it over a media, such as an RF or optical channel, or to record it onto a media, such as a disk. As such, many computer-readable media systems include circuits, software, or both, to perform data serialization and re-parallelization.

Parallel data (421) can be represented as the flow of data signals aligned in time, such that parallel data unit (byte, word, d-word, etc.) (422, 423, 424) is transmitted with each bit D₀-Dₙ being on a bus or signal carrier simultaneously, where the “width” of the data unit is n−1. In some systems, D₀ is used to represent the least significant bit (“LSB”), and in other systems, it represents the most significant bit (“MSB”). Data is serialized (421) by sending one bit at a time, such that each data unit (422, 423, 424) is sent in serial fashion, one after another, typically according to a protocol.

As such, the parallel data stored in computer memory (407, 407′) is often accessed by a microprocessor or Parallel-to-Serial Converter (425, 425′) via a parallel bus (421), and exchanged (e.g. transmitted, received, or transceived) via a serial bus (421′). Received serial data is converted back into parallel data before storing it in computer memory, usually. The serial bus (421′) generalized in FIG. 4c may be a wired bus, such as USB or Firewire, or a wireless communications medium, such as an RF or optical channel, as previously discussed.

In these manners, various embodiments of the invention may be realized by encoding software, data, or both, according to the logical processes of the invention, into one or more computer-readable mediums, thereby yielding a product of manufacture and a system which, when properly read, received, or decoded, yields useful programming instructions, data, or both, including, but not limited to, the computer-readable media types described in the foregoing paragraphs.

### CONCLUSION

While certain examples and details of a preferred embodiment have been disclosed, it will be recognized by those skilled in the are that variations in implementation such as use of different programming methodologies, computing platforms, and processing technologies, may be adopted without departing from the spirit and scope of the present invention. Therefore, the scope of the invention should be determined by the following claims.

What is claimed is:

1. A system comprising:
a patient role and at least one permission indicator;
an origin safeguard context including a patient origin location identifier, an associated origin space safeguard profile, and at least one associated previously-established set of control parameters, limit settings, and controllable device configurations;
a patient destination location identifier and an associated destination space safeguard profile;
a space configuration assessor configured to produce a destination safeguard context including a destination location set of control parameters, limit settings, and controllable device configurations by reconciling said origin safeguard context with said destination location identifier and safeguard profile; and
a space configuration controller which, responsive to said assessor, alters destination facility configurations according to said destination safeguard context.

2. The system as set forth in claim 1 wherein said space configuration assessor comprises an occupant role assignor which associates one or more role-based safety rules, permissions, and restrictions to a patient.

3. The system as set forth in claim 1 wherein said space profiles comprise a one or more safety rules.

4. The system as set forth in claim 1 wherein at least one of said destination location or origin location comprises a hospital room.

5. The system as set forth in claim 1 wherein said space configuration controller is configured to control one or more patient monitor devices.

6. The system as set forth in claim 1 wherein said space configuration controller is configured to control one or more gas valves.

7. The system as set forth in claim 1 wherein said space configuration controller is configured to control one or more electricity sources.

8. The system as set forth in claim 1 wherein said space configuration controller is configured to control one or more power furniture adjusters.

9. The system as set forth in claim 1 wherein said space configuration controller is configured to control one or more patient bedside instruments.

10. An automated method comprising:
providing a patient role and at least one permission indicator;
accessing an origin safeguard context including a patient origin location identifier, an associated origin space safeguard profile, and at least one associated previously-established set of control parameters, limit settings, and controllable device configurations;
receiving a patient destination location identifier and an associated destination space safeguard profile;
producing a destination safeguard context including a destination location set of control parameters, limit settings, and controllable device configurations by reconciling said origin safeguard context with said destination location identifier and safeguard profile; and
controlling one or more destination facility configurations according to said destination safeguard context.

11. The method as set forth in claim 10 further comprising associating one or more role-based safety rules, permissions, and restrictions to a patient.

12. The method as set forth in claim 10 wherein said space profiles comprise a one or more safety rules.

13. The method as set forth in claim 10 wherein at least one of said destination location or origin location comprises a hospital room.

14. The method as set forth in claim 10 wherein said step of controlling controls one or more patient monitor devices.

15. The method as set forth in claim 10 wherein said step of controlling controls one or more gas valves.

16. The method as set forth in claim 10 wherein said step of controlling controls one or more electricity sources.

17. The method as set forth in claim 10 wherein said step of controlling controls one or more power furniture adjusters.

18. The method as set forth in claim 10 wherein said step of controlling controls one or more patient bedside instruments.

19. An article of manufacture comprising:
a computer readable medium suitable for encoding software; and
computer-executable software encoded in said medium configured to perform the steps of:
(a) providing a patient role and permissions indicators;
(b) accessing an origin safeguard context including a patient origin location identifier, an associated origin space safeguard profile, and at least one associated previously-established set of control parameters, limit settings, and controllable device configurations;
(c) receiving a patient destination location identifier and an associated destination space safeguard profile;
(d) producing a destination safeguard context including a destination location set of control parameters, limit settings, and controllable device configurations by reconciling said origin safeguard context with said destination location identifier and safeguard profile; and
(e) controlling one or more destination facility configurations according to said destination safeguard context.

20. The article of manufacture as set forth in claim 19 wherein said destination facility configurations comprises a facility selected from the group of a patient monitor device, a gas valve, an electricity source, a power furniture adjuster, and a patient bedside instrument.
